(19) United States
(12) Patent Application Publication
(10) Pub. No.: US 2010/0060007 A1
(43) Pub. Date: Mar. 11, 2010

(54) Harness the energy of the oceans and lakes to produce electricity

(76) Inventor: Harry Bialor, Brooklyn, NY (US)

Correspondence Address: HARRY BIALDR, 1671 E. 17th St - APT - 2A, BROOKLYN, NY, 11229, US

(21) Appl. No.: 12/459,851

(22) Filed: Sep. 2, 2009

Related U.S. Application Data
(60) Provisional application No. 61/137,111, filed on Jul. 28, 2008.

(51) Int. Cl. F03B 13/14

(52) U.S. Cl. 290/53

(57) ABSTRACT

A heavy duty mat is placed at the edge of the ocean.

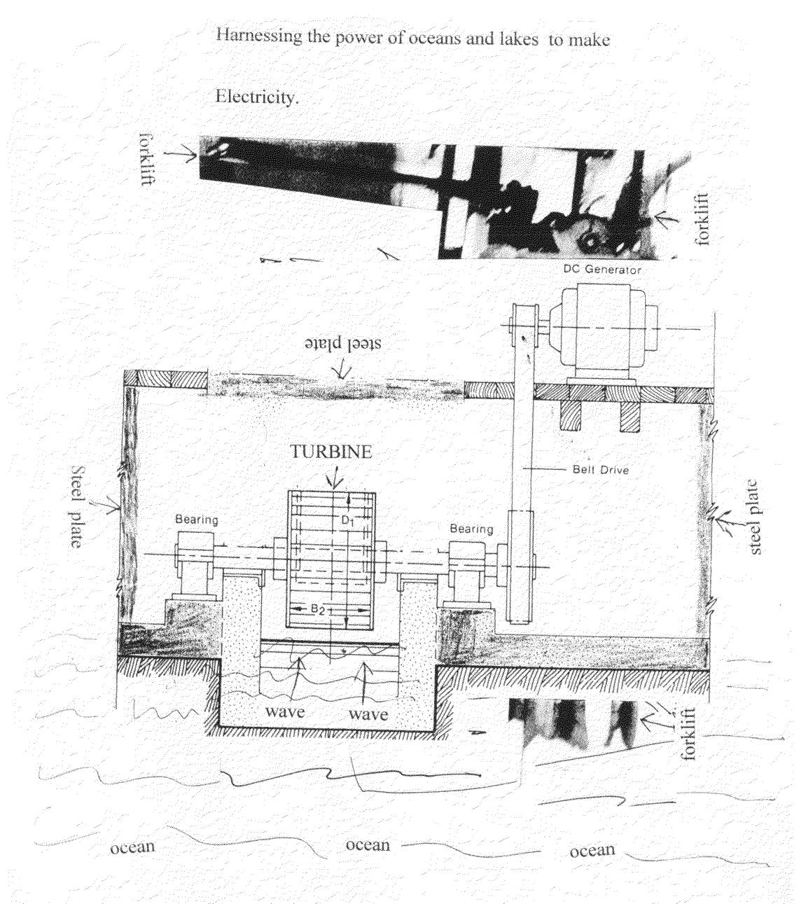

The plate is welded to the forklift. The turbine is firmly attached to the plate At the end of the forklift. The generator is firmly attached to the plate; Closest to the forklift. The whole unit is moved on to the mat at the edge Of the ocean. Both the generator and turbine have wheels. The belt is Wrapped firmly around both wheels. When the waves hit the turbine, The turbine turns, thereby turning the generator. As a result it produces Electricity.

For as long as we have waves, we will have pollution-free, Electricity.

I Claim priority to my earlier file provisional application 61/137,111. Title—HARNESSING THE ENERGY OF THE OCEANS AND LAKES TO PRODUCE ELECTRICITY.

This invention consist of the following components;

A] A forklift
B] A generator
C] A belt
D] A turbine
E] A metal plate.
F] A heavy duty mat.

### STEEL PLATE

This metal plate is firmly attached to the fork lift. All other parts of my invention are attached to the metal plate, except the belt. The cut out in the metal plate is for the turbine.

1. I claim that; this invention will provide us with a pollution free environment.
I claim that; for as long as there are waves, there will be pollution free electricity.
I claim that; we do not have to have huge power stations. There can be many small power stations all over the country and the world.

2. Besides the parts listed in the original application, I am adding a heavy duty plastic or rubber tract that the forklift will be moving on, because of high and low tides, the tract will have to be hollow inside and filled with cement to prevent it from moving around.

3. Typed and doubled spaced.

4. Drawing has the required margins.

5. I claim that; I used 4 people plus myself to take my invention to Far Rockaway, Queens, N.Y. to see if my invention works. My invention works.

6. I claim that; this invention is mobile. That is why the forklift is part of the invention. The forklift moves on a tract made of heavy duty plastic or rubber. This invention cannot be used at a shoreline where the water drops suddenly, because, the whole project will be washed away. A slow, gradually declining beach is ideal. It does not take a tremendous wave to turn a turbine. Safety is key.
The main parts consist of the following:
1) A Heavy Duty Tract (weighted down)
2) A Forklift
3) A metal Plate
4) A Turbine (or 2 turbines interconnected to the generator to provide a continuous flow of electricity.)
5) A Belt
6) A Generator
